(19) United States
(12) Patent Application Publication
(10) Pub. No.: US 2007/0080487 A1
(43) Pub. Date: Apr. 12, 2007

(54) Cutting board with built-in drawer tray federally sponsored research

(76) Inventor: John William Yartz, Anchorage, KY (US)

Correspondence Address: JOHN W. YARTZ, 12401 MISTLETOE ROAD, ANCHORAGE, KY, 40223, US

(21) Appl. No.: 11/246,798

(22) Filed: Oct. 11, 2005

(51) Int. Cl. B23Q 3/00

(52) U.S. Cl. 269/289 R

(57) ABSTRACT

A cutting board, intended primarily for normal domestic use in food preparation, but not limited to same, with a removable self-contained drawer tray designed into the cutting board. The drawer tray can be so positioned by the user such that food-stuff waste trimmings can quickly and conviently be swept off the cutting board and into the drawer tray. The drawer tray can be removed and used as a transport vehicle to take the waste trimmings to their disposition. The sweeping of waste trimmings into the drawer tray can be a continuing procedure, such that the work surface of the cutting board is fully utilized at all times.

### FEDERALLY SPONSORED RESEARCH

Not applicable

### SEQUENCE LISTING OR PROGRAM

Not applicable

### BACK GROUND—FIELD OF INVENTION

This invention relates to a cutting board with a self-contained drawer tray, specifically such that the drawer tray can be used for an improved and more efficient means of trimming and preparing food-stuffs.

### BACK GROUND—DESCRIPTION OF PRIOR ART

A study and observation of cutting boards in general has not revealed any prior art for a self-contained drawer tray to be furnished as an integral part of the cutting board. It also has not revealed any cutting boards designed so as to provide for such a drawer tray. Historically, cutting boards intended for ordinary domestic use in food preparation have been “stand-alone” utensils. The disposition of waste trimmings has been left up to the user, and no provision has been made to make this disposition easier, more efficient, neater, or less unattractive. The user can:

a. Sweep the waste trimmings off to the counter-top. These would then have to be retrieved and disposed of later.

b. Utilize some other kitchen utensil such as a plate, and sweep the waste trimmings onto the plate. The round perimeter of a plate does not lend itself to readily transfer the waste trimmings from a cutting board without unplanned spillage.

c. Sweep the waste trimmings off into the sink. Again, these would later need to be retrieved and put into a waste bin, or, if available, swept further in the sink to a food-waste disposer.

d. Permit the waste trimmings to accumulate on the cutting board. This is not only inconvenient; it also severely reduces the working area of the cutting board.

e. Use the cutting board as a transport vehicle and take the waste trimmings to their disposition. This is very inconvenient and unhandy.

All these options noted present the user with inconvenient and unattractive chores.

Objects and Advantages

Accordingly, the objects and advantages of my invention as described above are listed as follows:

a. To make it simpler to trim and cull food stuffs which require such a procedure;

b. To make a task which is usually inconvenient much easier;

c. To make a task which is unpleasant much less unpleasant;

d. To permit one hundred percent utilization of a cutting board work surface thru all stages of trimming and culling, because the drawer tray self-stored in the cutting board is specifically designed to accept the waste trimmings as a continuing process;

e. To have a convenient utensil readily available as an integral part of the cutting board, and not require the user to search and procure a separate utensil;

f. To have a convenient utensil contained in the body of the cutting board which is uniquely designed for the special purpose of accepting waste trimmings;

g. To provide a convenient utensil for transporting the waste trimmings from the preparation area to a waste bin or food-waste disposer;

h. To provide a convenient utensil from which it is much easier to dispose of the waste trimmings than any of the various kitchen utensils pressed into service for this purpose.

### SUMMARY

In accordance, my invention provides a cutting board, most normally used in domestic service for trimming and culling food stuffs with a self-contained drawer tray. This drawer tray is uniquely designed to make the chore of disposing waste trimmings much easier, simpler, less messy and more efficient.

### DRAWINGS

Drawing Figures

FIG. 1 is a plan view of my invention, with drawer tray, FIG. 4 almost fully with-drawn from its telescoped position.

FIG. 3 is a side view of FIG. 1.

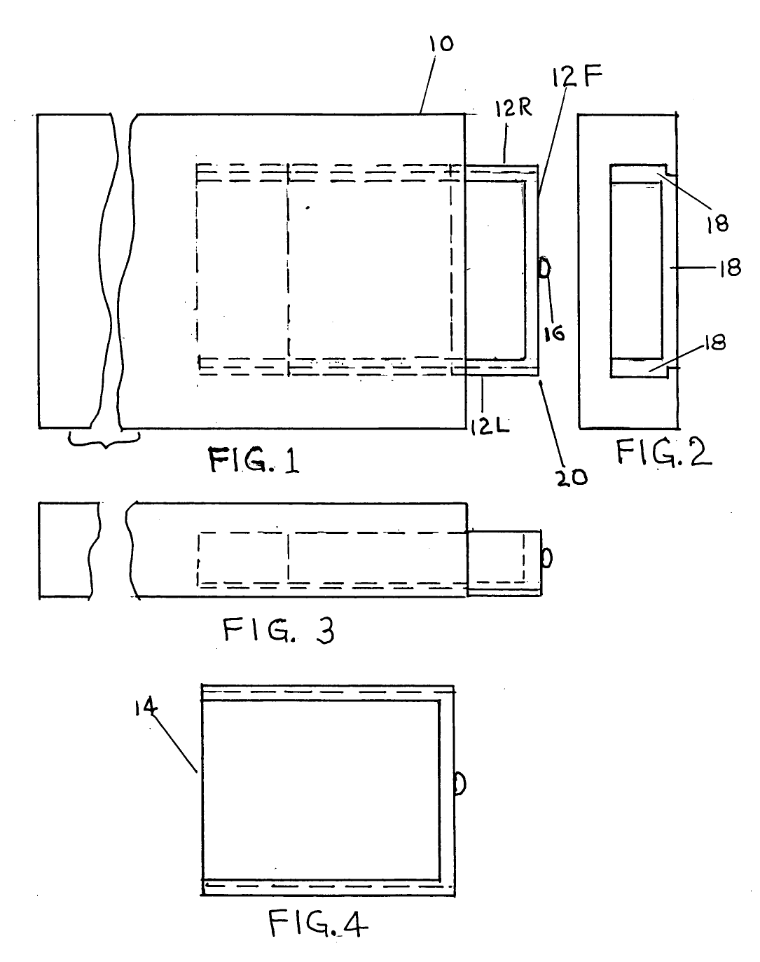

FIG. 2 is the end view of FIG. 1 with the drawer tray entirely removed.

FIG. 4 is a plan view of the drawer tray, showing the absence of a rear wall or lip.

### Reference Numerals in Drawings

10 cutting board

12R left wall or lip of drawer tray

12L left wall or lip of drawer tray

12F front wall or lip of drawer tray

14 floor of drawer tray

16 pull knob of drawer tray

18 voided opening or pocket fashioned in cutting board

20 drawer tray

### DETAILED DESCRIPTION

Description—FIG. 1 and FIG. 2

A practical and most effective embodiment of my invention is shown in FIG. 1 (top view) and in FIG. 2 (end view of cutting board 19 with drawer tray 20 removed). In FIG. 1 a cutting board 10 is shown with drawer tray 20 partially withdrawn from its storage pocket opening 18. The anticipated function of the cutting board 10 is its use in normal food preparation in normal use. The use envisioned for cutting board 10 is to prepare food-stuffs normally associated with food preparation. Such use almost always results in the generation of waste trimmings (not shown). The disposition of waste trimmings (not shown is made much more convenient by providing a drawer tray 20 as an integral part of cutting board 10.

When not in use, drawer tray 20 is neatly and slidably telescoped out of the way into storage pocket 18. Cutting board 10 is so configured as to provide the storage pocket 18.

For use, drawer tray 20 is pulled out using knob 16, to a position judged must proper for the task at hand.

Waste trimmings (not shown) which are produced can be efficiently and quickly brushed or swept off the work surface of the cutting board 10 onto the floor 14 of drawer tray 20. The retaining walls or lips 12R, 12L and 12F are to provide retention of waste trimmings (not shown), such that the waste trimmings (not shown) can be easily disposed of as necessary.

Providing drawer tray 20 as an integral part of cutting board 10 makes for a much more efficient kitchen utensil. Drawer tray 20 is always available because it is stored in the storage pocket 18 of cutting board 10. Because it is removable, drawer tray 20 can be used to transport waste trimmings (not shown) to their final disposition. The absence of a lip such as Lips 12R, 12L and 12F at the rear of the drawer tray 20, FIG. 4, makes the disposition of waste trimmings (not shown) much more simple than had the waste trimmings (not shown) been collected in a separate kitchen utensil, which normally has retaining lips on the entire perimeter. Conversely, had the preparer used some other kitchen utensil absent all restraining lips, the opportunity for inconvenient spillage would always be present.

Advantages

From the description above, a number of advantages of my invention are readily apparent. A drawer tray, integrally designed into a cutting board, provides an always-ready utensil for the disposition of waste trimmings. A drawer tray so designed for the specific function of capturing waste trimmings is more efficient and simpler to use. The use of some other utensil not specifically designed for such a function is less efficient and more difficult to use.

Operation—FIGS. 1, 2, 4

The operation of using the drawer tray 20 (FIG. 4) is very simple. The food preparer positions the drawer tray 20 to a suitable position as in FIG. 1 so as to conveniently sweep waste trimmings (not shown) onto the floor 14 of the drawer tray 20. When the task is complete the food preparer can use the drawer tray 20 to transport the waste trimmings (not shown) to a waste bin or food disposer.

### Conclusion and Scope

Accordingly, the reader will see that:

a cutting board with a self-contained drawer tray, always available when needed and designed to work efficiently and in conjunction with the cutting board., makes the chore of trimming food stuffs much less unpleasant and also simpler;

the uniquely designed drawer tray is much more efficient in ridding the work area of waste trimmings;

the unique design of the drawer tray without a rear lip makes it much easier to clean.

the reader will also note that the drawer tray, because of its dedicated use, not ever intended for food serving, does not need hygenic cleaning after use.

Although the description above contains several specifications, these should not be construed as limiting the scope, but merely providing a preferred embodiment. Thus the scope of the invention should be determined by the appended claims.

I claim:

1. An improved means for the disposition of waste trimmings from cutting boards; compromising:
a. a cutting board having the construction feature permitting the storage therein of a drawer tray,
b. said drawer tray having the construction feature permitting storage of said drawer tray within the body of said cutting board,
c. the means for conveniently positioning said drawer tray for accepting waste trimmings when said cutting board is used in its normal function of trimming food-stuffs,
d. said drawer tray having the construction feature which permits removal of said drawer tray from said cutting board,
whereby a user of said cutting board can more conviently and efficiently prepare food stuffs and also clear the work area of food-stuff waste trimmings as needed.
